(19) United States
(12) Patent Application Publication
(10) Pub. No.: US 2015/0046360 A1
(43) Pub. Date: Feb. 12, 2015

(54) CLOUD-BASED ACADEMIC MANAGEMENT SYSTEM FOR STUDENT-ATHLETES

(71) Applicant: Kelly Pierce, Miami, FL (US)

(72) Inventor: Kelly Pierce, Miami, FL (US)

(21) Appl. No.: 14/454,055

(22) Filed: Aug. 7, 2014

Related U.S. Application Data
(60) Provisional application No. 61/863,191, filed on Aug. 7, 2013.

(51) Int. Cl. G06Q 50/20; G06Q 10/10

(52) U.S. Cl. CPC G06Q 50/205; G06Q 10/10
USPC 705/326

(57) ABSTRACT

A cloud-based academic management system for student-athletes is disclosed. The system includes a database for storing student-athlete records including contact information, academic records and test scores for the student-athlete, and eligibility rules for execution on the student-athlete records, wherein a rule comprises an if-portion composed of a statement that is evaluated against data from a student-athlete record and a then-portion composed of a resulting conclusion that is triggered when the if-portion is evaluated, wherein each conclusion pertains to eligibility of a student-athlete to engage in an activity at a college level. The system also includes a server comprising a processor configured for authenticating submissions of academic records and test scores for student-athletes so as to ensure that said submissions originate from a trusted source, executing the eligibility rules upon student-athlete records, thereby producing conclusions regarding eligibility of a student-athlete to engage in an activity.

### CROSS-REFERENCE TO RELATED APPLICATIONS

This patent application claims priority to provisional patent application No. 61/863,191 filed Aug. 7, 2013 and entitled “Cloud Based Academic Management System for Student Athletes.” The subject matter of provisional patent application No. 61/863,191 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to electronic commerce and, more specifically, to academic management systems.

### BACKGROUND

In order to be eligible to play sports in college or at a university, a high school student-athlete is required to meet certain eligibility criteria defined by the National Collegiate Athletic Association (NCAA). The eligibility criteria include a combination of required courses, test score requirements, grade-point average (GPA) requirements, and the like. In recent years, however, the eligibility standards have increased, making it more challenging for student-athletes to compete at a Division I level. Division I is the highest level of intercollegiate athletics defined by NCAA in the United States. Division I schools include the major collegiate athletic institutions, with larger budgets, more elaborate facilities, and more athletic scholarships than lower divisions. For this reason, many student-athletes are desirous of playing sports at Division I schools.

One of the eligibility requirements includes meeting the requirements defined in a sliding scale based on the student-athlete's GPA computed from a student's core courses defined by the NCAA, coupled with the total scores from Scholastic Assessment Test (SAT) and/or the American College Testing (ACT) of the student-athlete. To qualify to play sports in college, a student-athlete must score higher on their GPA, if they endure a lower SAT or ACT score. If the student scored higher SAT or ACT scores, a lower GPA is required. The requirements of the sliding scale have increased as part of the effort to enhance eligibility criteria.

Another one of the eligibility requirements includes taking certain core courses defined by the NCAA. Historically, only a student's grades for core courses were considered eligibility requirements. Recently, however, the NCAA is “grandfathering” in courses or classes that were taken prior to a predefined date or milestone. The said inclusion or grandfathering means that any lower grades earned by a student-athlete in earlier years of high school will be now be incorporated by the NCAA into their sliding scale calculations, if they are not remediated by the start of the student-athlete's senior year of high school. This has produced some uncertainty when calculating a student-athlete's eligibility.

The above-described problems associated with calculating student-athlete eligibility are compounded by the fact that most high school counselors are generally overloaded with work. The current student-to-counselor ratio in most high schools in the United States is extremely high. This limits the ability of most high school counselors to assist student-athletes in meeting eligibility requirements. Further, assisting student-athletes to meet college sport eligibility requirements set by the NCAA is not part of most high school counselors' job descriptions. This serves as an additional barrier for student athletes to determine whether they are eligible to play sports in college.

It should further be noted that many colleges that recruit star high school student-athletes for their athletic programs predominantly start tracking them during their junior year in high school. These colleges request transcripts of student-athletes after the end of every semester. Thus, if a high school has one star student-athlete, who is being recruited by 20 colleges, the high school (or its counselor) must send 20 different transcripts every semester and communicate with each of the 20 college representatives via 20 different phone calls. If the same high school has 5 or 10 student-athletes who are being recruited, the numbers above are multiplied, thus making it extremely difficult for a high school (or its counselor) to effectively help and manage the academics of each student-athlete therein.

Consequently, a need exists to overcome the problems with the prior art as discussed above, and particularly a more efficient system for academic management for student-athletes.

### SUMMARY

According to the aspects illustrated herein, a cloud-based academic management system for student-athletes is disclosed. The system includes a database for storing: a plurality of student-athlete records, wherein each record includes contact information for a student-athlete, academic records for the student-athlete and test scores for the student-athlete; and a plurality of eligibility rules for execution on the student-athlete records, wherein a rule comprises an if-portion composed of a statement that is evaluated against data from a student-athlete record and a then-portion composed of a resulting conclusion that is triggered when the if-portion is evaluated, wherein each conclusion pertains to eligibility of a student-athlete to engage in a predefined activity at a college level. The system also includes a server connected to the database and to a communications network via a network interface connection, the server comprising a processor configured for: authenticating submissions of academic records and test scores for student-athletes so as to ensure that said submissions originate from a trusted source; providing authenticated access to the database to users; executing the plurality of eligibility rules upon one or more student-athlete records, thereby producing one or more conclusions regarding eligibility of a student-athlete to engage in a predefined activity at a college level; and generating one or more reports regarding the eligibility of said student-athlete to engage in the predefined activity at the college level.

This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

### BRIEF DESCRIPTION OF THE DRAWINGS

The accompanying drawings, which are incorporated in and constitute a part of this disclosure, illustrate various example embodiments. In the drawings:

FIG. 1 is a block diagram illustrating the network architecture of an academic management system for student-athletes, in accordance with one embodiment.

FIG. 2 is a block diagram showing the data flow pertaining to the academic management system for student-athletes, according to one embodiment.

FIG. 3 is a flow chart depicting the general control flow of a process for providing an academic management system for student-athletes over a communications network, according to one embodiment.

FIG. 4 is a block diagram of a system including an example computing device and other computing devices.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

In accordance with the embodiments described herein, the cloud-based academic management system for student-athletes disclosed overcomes shortcomings of the prior art by providing the user with an online, user-friendly, depository system for implementation of academic management data for high school student-athletes via an e-commerce platform. The disclosed embodiments are a cloud-based system that facilitates student-athletes, family members and the high school or college academic counselors to better manage student-athletes' academic performances, as they pertain to constantly changing college sports eligibility requirements. The disclosed embodiments allow student-athletes to keep tabs on their academic performance, to flag any potential eligibility risks, to project the test scores or GPA needed, and to enable student-athletes to take ownership of their academic future as incoming freshmen. Using the disclosed embodiments, a student-athlete will not succumb to failure in later years of high school due to lack of attention to academic details, diminutive quality in academic assistance, or ambiguity in forecasting their eligibility requirements, thereby ensuring success as a college athlete.

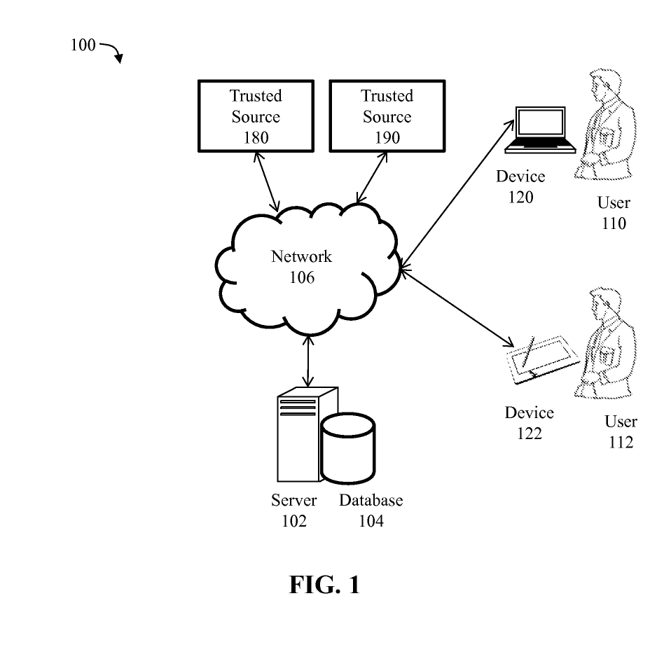

Referring now to the drawing figures in which like reference designators refer to like elements, there is shown in FIG. 1 an illustration of a block diagram showing the network architecture of a system 100 and method for providing an academic management system for student-athletes in accordance with one embodiment. A prominent element of FIG. 1 is the server 102 associated with repository or database 104 and further coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, facilitating academic management system for student-athletes.

FIG. 1 includes stationary or mobile computing devices 120 and 122, which may be smart phones, mobile phones, tablet computers, handheld computers, laptops, or the like. Computing devices 120 and 122 correspond to users 110 and 112, who may be a student-athlete, a counselor, a principal, a coach, an academic advisor, a recruiter, a high school representative or any other family member of the student-athlete.

FIG. 1 further shows that server 102 includes a database or repository 104, which may be a relational database comprising a Structured Query Language (SQL) database stored in a SQL server. Devices 120, 122 may also each include their own database. The repository 104 serves data from a database, which is a repository for data used by server 102 and devices 120, 122 during the course of operation of the disclosed embodiments. Database 104 may be distributed over one or more nodes or locations that are connected via network 106.

The database 104 may include a user record for each user 110 or 112. A user record may include: contact/identifying information for the user (name, address, telephone number(s), email address, date of birth, social security number, etc.), a user address identifier (such as an email address, text message address, UseNet address, mobile phone number, etc), etc. A user record may also include a unique identifier for each user, a residential address for each user, the current location of each user (based on location-based services from the user's mobile computer) and demographic data for each user, such as age, sex, income data, race, color, marital status, etc.

The database 104 may include a student-athlete record for each student-athlete. The student-athlete record may include a student-athlete's transcripts, a list of courses taken, a list of grades for each course, a Grade Point Average (GPA) for the current semester (or each past semester and a cumulative GPA), a list of standardized tests taken, a list of standardized test scores, etc. The student-athlete record may also include an academic record, which includes a list of courses taken by a student-athlete and a corresponding list of grades received by the student-athlete for said courses. The student-athlete record may also include any data from a user record.

The database 104 may include a plurality of test-score rules for execution on data from the student-athlete records. A rule comprises an if-portion composed of a statement that is evaluated against data from a student-athlete record and a then-portion composed of a resulting conclusion that is triggered when the if-portion is evaluated and the if-portion is true, wherein each conclusion pertains to whether a student-athlete has met test-score and grade requirements. Recall that one of the eligibility requirements includes meeting the requirements defined in a sliding scale based on the student-athlete's GPA computed from a student's core courses, coupled with the total scores from standardized tests of the student-athlete. The sliding scale defines a list of test scores, wherein each test score is paired with a minimum GPA required to be eligible. Seen another way, the sliding scale defines a list of GPA values, wherein each GPA value is paired with a minimum test score required to be eligible. To qualify to play sports in college, a student-athlete must score higher on their GPA, if they endure a lower test score. If the student scored higher test scores, a lower GPA is required. The conclusions of the test score rules indicates whether a student-athlete has met test-score and grade requirements, as defined by the sliding scale. A conclusion may be a text string (such as “requirements met”) that indicates a student-athlete has met the requirements.

In one example, a test-score rule may be “if the student's GPA is between 2.0 and 2.4, and the ACT score is at least 240, then the student has met the test-score and grade requirement.” In another example, a test-score rule may be “if the student's GPA is between 3.0 and 3.4, and the ACT score is at least 200, then the student has met the test-score and grade requirement.”

The database 104 may also include a plurality of a plurality of eligibility rules for execution on the student-athlete records and on conclusions from execution of the test-score rules, wherein each conclusion pertains to eligibility of a student-athlete to engage in a predefined activity at a college level. When executed, the eligibility rules determine (based on the student-athlete record data) whether the student-athlete has taken the required core courses, whether missed courses or failed/low grade course have been remediated in time (by taking a replacement course before a time deadline), whether certain courses have been grandfathered in, whether required transcripts have been uploaded to the system, etc. The conclusions of the eligibility rules indicates eligibility of a student-athlete to engage in a predefined activity at a college level. A conclusion may be a text string (such as “eligible”) that indicates a student-athlete is eligible. In one embodiment, eligibility rules also make the same determinations and make the same conclusions as those reached by test score rules.

Following are examples of eligibility rules:

“if a course on the student's transcript is listed on a predefined list of approved courses, then said course is defined as a core course”

“if a student's transcript shows at least 16 core courses and at least three of those courses are English courses, at least 3 of those courses are Math courses, at least 2 of those courses are Science courses, and at least 4 of those courses are approved other courses, then the student is eligible”

“if the student has met the test-score and grade requirement, and the student's transcript has at least 16 core courses, then the student is eligible”

“if the student's transcript has less than 16 core courses, then the student is not eligible”

“if the student's GPA is 2.0 or less for the student's 16 core courses, then the student is not eligible to play for Division I”

“if the student's GPA is between 2.0 and 2.3 for the student's 16 core courses, then the student may sit in the college and practice with the team but is not eligible to play for Division I”

“if the student has less than 10 core courses before the start of his 7th semester in high school, then the student is not eligible to play for Division I”

The database 104 may also include a plurality of alert definitions that define when an alert is sent to one or more users of the system, wherein an alert definition includes one or more user address identifiers and one or more conclusions pertaining to eligibility of a student-athlete to engage in a predefined activity at a college level. For example, an alert definition may specify that if, upon execution of the rules, it is determined that a student-athlete is not eligible, then a text message is sent to a student athlete. In another example, an alert definition may specify that if, upon execution of the rules, it is determined that a student-athlete has not test-score and/or grade requirements, then an email message is sent to a student athlete and his guidance counselor.

The database 104 may also include a list of trusted credentials corresponding to a list of trusted sources. This list is used to determine that a source is a trusted source, or an entity that has relevant authority. The database 104 may also include a list of authorized credentials corresponding to a list of users. This list is used to determine that a user is allowed access to the system.

FIG. 1 shows an embodiment of the present invention wherein networked computing devices 120, 122 interact with server 102 and repository 104 (as well as entities 180 and 190) over the network 106. Server 102 includes a software engine that delivers applications, data, program code and other information to networked computing devices 120, 122 (as well as entities 180 and 190). It should be noted that although FIG. 1 shows only the networked computers 102, 120, 122, 180 and 190, the system of the disclosed embodiments supports any number of networked computing devices connected via network 106. Further, server 102, entities 180 and 190, and devices 120, 122 include program logic such as computer programs, mobile applications, executable files or computer instructions (including computer source code, scripting language code or interpreted language code that may be compiled to produce an executable file or that may be interpreted at run-time) that perform various functions of the disclosed embodiments. The term cloud-based is meant to refer to the ability of outside entities or remote entities (such as networked computers 102, 120, 122, 180 and 190) to access server 102 and database 104 from remote locations via the network 106.

Note that although server 102 is shown as a single and independent entity, in one embodiment, the functions of server 102 may be integrated with another entity, such as one of the devices 120, 122, and 180, 190. Further, server 102 and its functionality, according to a preferred embodiment, can be realized in a centralized fashion in one computer system or in a distributed fashion wherein different elements are spread across several interconnected computer systems.

FIG. 1 also shows trusted sources 180, 190, which may be third party entities that can be trusted to provide true and correct information for student-athlete records. This includes schools and colleges (that provide official transcripts), testing companies (that provide official test scores), etc. Trusted sources 180, 190 may also include the NCAA or other governing bodies for sports.

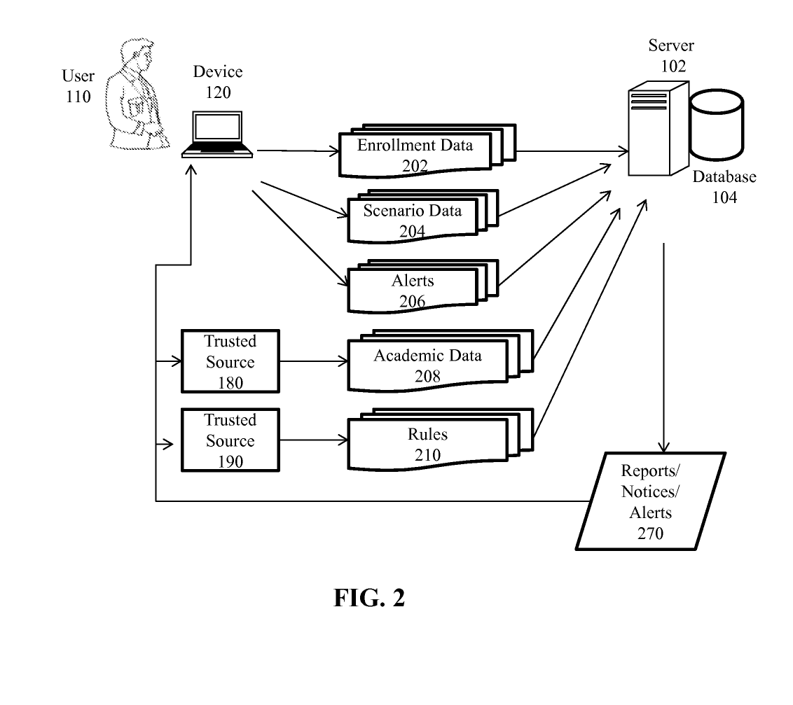

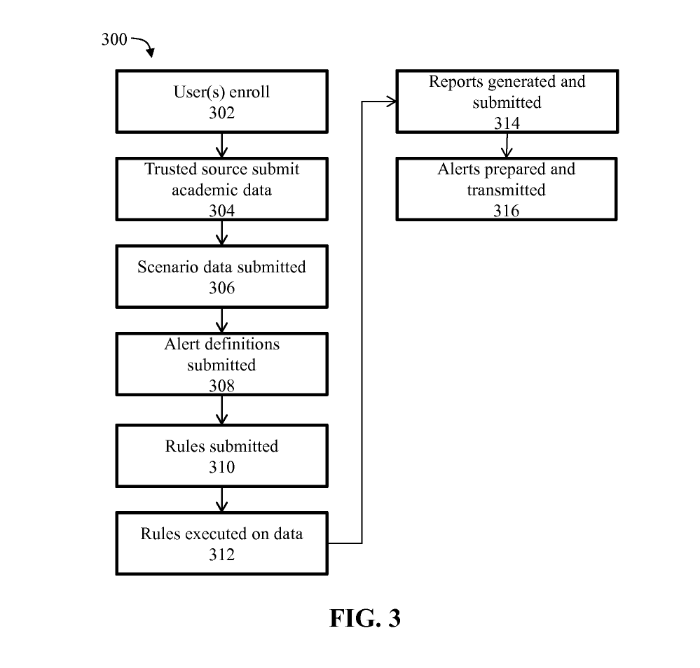

The process of academic management over a communications network will now be described with reference to FIGS. 2 through 3 below. FIGS. 2-3 depict the data flow and control flow in the process for facilitating academic management over a communications network 106, according to one embodiment. The process of the disclosed embodiments begins with optional step 302 (see flowchart 300), wherein the users 110 and/or 112 may enroll or register with server 102, or third parties 180/190. In the course of enrolling or registering, user 110 may enter data into his device 120 by manually entering data into a mobile application via keypad, touchpad, or via voice. In the course of enrolling or registering, the user 110 may enter any data that may be stored in a user record or student athlete record, as defined above, such as enrollment data 202. Also in the course of enrolling or registering, the server 102, or 180/190 may generate a user record and/or student-athlete for each registering user/student-athlete and store the user record and/or student-athlete record in an attached database, such as database 104. In one alternative, the data entered during enrollment (such as data 202) is entered by an administrator at a school or other learning institution.

Note that when logging on to server 102 in step 302, the user 110 must provide authorized credentials to server 102. Said credential is an attestation of qualification, competence, or authority issued to an individual user by a third party (such as server 102) with authority or assumed competence to do so. The credentials may include identifying data, passwords, encrypted files, etc. The server 102 checks the credentials provided against a list of user credentials. This list is used to determine that a user is allowed access to the system. In this way, the server 102 authenticates the user 110 before he is given access to the system.

In the next step 304, one or more trusted sources 180/190 submit academic data (such as data 208) about a student-athlete to server 102. Data 208 may be academic records, test scores, grades, transcripts, course descriptions, syllabi, behavior reports, etc. Note that when sending submissions to server 102 in step 304, the trusted sources 180/190 must provide trusted credentials to server 102. The server 102 checks the trusted credentials provided against a list of trusted credentials. This list is used to determine that a source is a trusted source, or an entity that has relevant authority. In this way, the server 102 provides authenticated access to a trusted source before it is allowed to submit data to the system. The purpose of the trusted nature of step 304 is to ensure the integrity of the data being submitted. For example, test scores may only be accepted directly from a testing company or directly from a school, to ensure no one has tampered with the data. In another example, grade data or transcript data may only be accepted directly from a school or from a learning institution to ensure its integrity. In another example, age data (such as birth certificate or identification card) may only be accepted from an official government office, such as the Office of Vital Statistics.

In optional step 306, user 110 submits scenario data 204 to server 102. The user 110 may enter facts or data as hypothetical scenarios and have the eligibility rules and test score rules executed upon the hypothetical scenarios, in order to determine the conclusions that correspond to the hypothetical scenarios. For example, if the student predicts he will receive a “D” in a particular class, the student may enter this fact as a hypothetical scenario and have the eligibility rules and test score rules executed upon the hypothetical scenario, in order to determine whether he would be eligible to engage in the predefined activity at the college level, according to the hypothetical scenarios. This feature is advantageous as it allows the student to plan ahead of time, based on the resulting conclusions.

Scenario data 204 may include any of the data in 208 or 202. In one embodiment, since scenario data 204 is only predicted data or only for the purpose of the evaluating what-if scenarios, the data 204 is not committed to memory or permanently saved to the user records or student-athlete records as true or real data. In one embodiment, since scenario data 204 is only predicted data, the data 204 (when indicated by user 110 as being scenario data) may be saved to the user records or student-athlete records as predicted or scenario data that is not used during the execution of test-score rules and eligibility rules when a user desires to determine the actual or real eligibility of a student-athlete. As such, when the data 204 is saved to the user records or student-athlete records, it may be stamped or otherwise flagged as predicted or scenario data.

In optional step 308, user 110 submits alert data 206 to server 102. The user 110 may enter alert definitions that define when an alert is sent to one or more users of the system, wherein an alert definition includes one or more user address identifiers and one or more conclusions pertaining to eligibility of a student-athlete to engage in a predefined activity at a college level.

In step 310, a trusted source 190 submits rules 210 (such as eligibility rules and/or test score rules) to server 102. The trusted source 190 must provide trusted credentials to server 102 before submitting the rules 210. In this way, the server 102 provides authenticated access to the trusted source 190 before it is allowed to submit data to the system. In one embodiment, the trusted source 190 may submit data necessary to evaluate the rules, such as a predefined list of approved courses, used to determine whether a course is a core course.

In step 312, the server 102 executes the plurality of test-score rules upon one or more student-athlete records, thereby producing one or more conclusions regarding whether a student-athlete has met test-score and grade requirements. Subsequently, the server 102 may execute the plurality of eligibility rules upon one or more student-athlete records and upon the conclusions from execution of the test-score rules, thereby producing one or more conclusions regarding eligibility of said student-athlete to engage in a predefined activity at a college level. In one embodiment, if the user 110 indicates that it desires to determine the actual or real eligibility of a student-athlete, the server 102 ignores any data that has been stamped or otherwise flagged as predicted or scenario data 204.

Next, in step 314, the server 102 generates one or more reports regarding test-score and grade requirements, and regarding the eligibility of said student-athlete to engage in the predefined activity at the college level. The one or more reports (270) are transmitted for display on device 120 of user 110 (or the devices or other users such as 112) or transmitted for viewing by trusted sources 180/190. A report may be a text document for viewing by a user, wherein said document is attached to an email message or text message. A report may also be an HTML document that is transmitted for viewing at a web browser. The report may include conclusions comprising text strings that indicate whether test score and grade requirements have been met and/or text strings that indicate eligibility of a student-athlete to engage in a predefined activity at a college level. In one embodiment, if the user 110 has submitted scenario data 204 to generate the reports 270, the report is stamped or otherwise flagged as using predicted or scenario data 204. Otherwise, the report may be stamped or otherwise flagged as not using predicted or scenario data 204.

In one optional step 316, the server 102 reads the one or more alert definitions 206 and compares them to the one or more conclusions regarding eligibility so as to determine that an alert must be sent to one or more users. If the server 102 determines that the conclusions match the data defined in the alert definitions 206, then server 102 prepares and sending a message 270 to said one or more users via the one or more user address identifiers provided in the one or more alert definitions.

In one alternative to step 312, the server 102 executes solely the plurality of eligibility rules upon one or more student-athlete records, thereby producing one or more conclusions regarding eligibility of said student-athlete to engage in a predefined activity at a college level. Then, in an alternative step 314, the server 102 generates one or more reports regarding eligibility of said student-athlete to engage in the predefined activity at the college level.

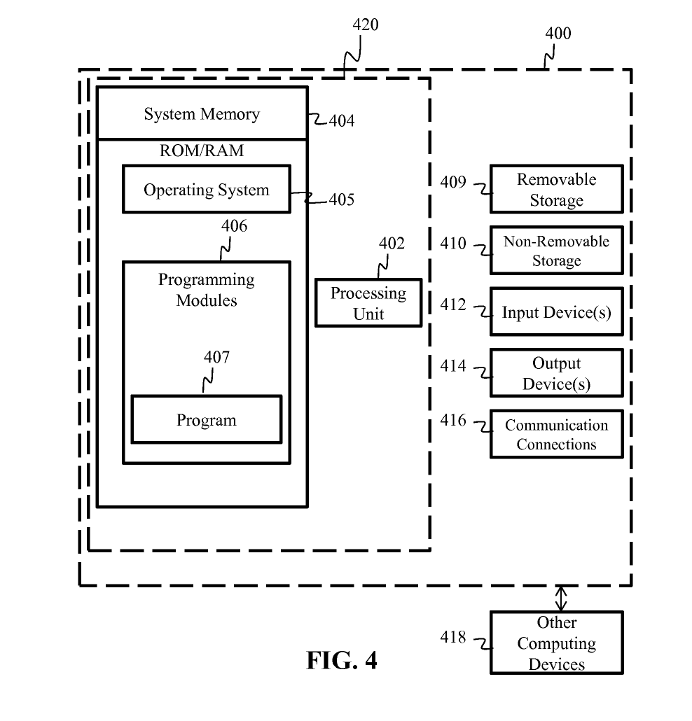

FIG. 4 is a block diagram of a system including an example computing device 400 and other computing devices. Consistent with the embodiments described herein, the aforementioned actions performed by 102, 120, 122 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for the methods shown in FIGS. 2-3 above.

With reference to FIG. 4, a system consistent with an embodiment of the invention may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination or memory. System memory 404 may include operating system 405, one or more programming modules 406 (such as program module 407). Operating system 405, for example, may be suitable for controlling computing device 400's operation. In one embodiment, programming modules 406 may include, for example, a program module 407. Furthermore, embodiments of the invention may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. The aforementioned devices are only examples, and other devices may be added or substituted.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 may perform processes including, for example, one or more of the methods shown in FIGS. 2-3 above. The aforementioned processes are examples, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A cloud-based academic management system for student-athletes, the system comprising of:
a database for storing:
a plurality of student-athlete records, wherein each record includes contact information for a student-athlete, academic records for the student-athlete and test scores for the student-athlete; and
a plurality of eligibility rules for execution on the student-athlete records, wherein a rule comprises an if-portion composed of a statement that is evaluated against data from a student-athlete record and a then-portion composed of a resulting conclusion that is triggered when the if-portion is evaluated, wherein each conclusion pertains to eligibility of a student-athlete to engage in a predefined activity at a college level; and
a server connected to the database and to a communications network via a network interface connection, the server comprising a processor configured for:
authenticating submissions of academic records and test scores for student-athletes so as to ensure that said submissions originate from a trusted source;
providing authenticated access to the database to users;
executing the plurality of eligibility rules upon one or more student-athlete records, thereby producing one or more conclusions regarding eligibility of a student-athlete to engage in a predefined activity at a college level; and
generating one or more reports regarding the eligibility of said student-athlete to engage in the predefined activity at the college level.

2. The cloud-based academic management system of claim 1, wherein an academic record includes a list of courses taken by a student-athlete and a corresponding list of grades received by the student-athlete for said courses.

3. The cloud-based academic management system of claim 2, wherein a conclusion comprises a text string that indicates eligibility of a student-athlete to engage in a predefined activity at a college level.

4. The cloud-based academic management system of claim 3, wherein the step of authenticating submissions comprises soliciting credentials from a source of a submission and verifying said credentials against a list of trusted credentials so as to determine that said source is a trusted source.

5. The cloud-based academic management system of claim 4, wherein the step of providing authenticated access comprising soliciting credentials from a user and verifying said credentials against a list of authorized credentials so as to determine that said user is allowed access to the system.

6. The cloud-based academic management system of claim 5, wherein the one or more reports include text strings that indicate eligibility of a student-athlete to engage in a predefined activity at a college level.

7. The cloud-based academic management system of claim 6, further comprising preparing and sending a message to a student-athlete via a user address identifier provided in the contact information in the corresponding student-athlete record, wherein said message includes the one or more reports.

8. A cloud-based academic management system for student-athletes, the system comprising of:
a database for storing:
a plurality of student-athlete records, wherein each record includes contact information for a student-athlete, academic records for the student-athlete and test scores for the student-athlete;
a plurality of test-score rules for execution on the student-athlete records, wherein a rule comprises an if-portion composed of a statement that is evaluated against data from a student-athlete record and a then-portion composed of a resulting conclusion that is triggered when the if-portion is evaluated, wherein each conclusion pertains to whether a student-athlete has met test-score and grade requirements;
a plurality of eligibility rules for execution on the student-athlete records and on conclusions from execution of the test-score rules, wherein each conclusion pertains to eligibility of a student-athlete to engage in a predefined activity at a college level; and
a server connected to the database and to a communications network via a network interface connection, the server comprising a processor configured for:
authenticating submissions of academic records and test scores for student-athletes so as to ensure that said submissions originate from a trusted source;
providing authenticated access to the database to users;
executing the plurality of test-score rules upon one or more student-athlete records, thereby producing one or more conclusions regarding whether a student-athlete has met test-score and grade requirements;
executing the plurality of eligibility rules upon one or more student-athlete records and upon the conclusions from execution of the test-score rules, thereby producing one or more conclusions regarding eligibility of said student-athlete to engage in a predefined activity at a college level; and
generating one or more reports regarding test-score and grade requirements, and regarding the eligibility of said student-athlete to engage in the predefined activity at the college level.

9. The cloud-based academic management system of claim 8, wherein an academic record includes a list of courses taken by a student-athlete and a corresponding list of grades received by the student-athlete for said courses.

10. The cloud-based academic management system of claim 9, wherein a conclusion of test-score rules comprises a text string that indicates whether a student-athlete has met test-score and grade requirements and wherein a conclusion of eligibility rules comprises a text string that indicates eligibility of a student-athlete to engage in a predefined activity at a college level.

11. The cloud-based academic management system of claim 10, wherein the step of authenticating submissions comprises soliciting credentials from a source of a submission and verifying said credentials against a list of trusted credentials so as to determine that said source is a trusted source.

12. The cloud-based academic management system of claim 11, wherein the step of providing authenticated access comprising soliciting credentials from a user and verifying said credentials against a list of authorized credentials so as to determine that said user is allowed access to the system.

13. The cloud-based academic management system of claim 12, wherein the one or more reports include text strings that indicate whether a student-athlete has met test-score and grade requirements and include text strings that indicate eligibility of a student-athlete to engage in a predefined activity at a college level.

14. The cloud-based academic management system of claim 13, further comprising preparing and sending a message to a student-athlete via a user address identifier provided in the contact information in the corresponding student-athlete record, wherein said message includes the one or more reports.

15. A cloud-based academic management system for student-athletes, the system comprising of:
a database for storing:
a plurality of student-athlete records, wherein each record includes contact information for a student-athlete, academic records for the student-athlete and test scores for the student-athlete;
a plurality of eligibility rules for execution on the student-athlete records, wherein a rule comprises an if-portion composed of a statement that is evaluated against data from a student-athlete record and a then-portion composed of a resulting conclusion that is triggered when the if-portion is evaluated, wherein each conclusion pertains to eligibility of a student-athlete to engage in a predefined activity at a college level; and
one or more alert definitions that define when an alert is sent to one or more users of the system, wherein an alert definition includes one or more user address identifiers and one or more conclusions pertaining to eligibility of a student-athlete to engage in a predefined activity at a college level; and
a server connected to the database and to a communications network via a network interface connection, the server comprising a processor configured for:
authenticating submissions of academic records and test scores for student-athletes so as to ensure that said submissions originate from a trusted source;
providing authenticated access to the database to users;
executing the plurality of eligibility rules upon one or more student-athlete records, thereby producing one or more conclusions regarding eligibility of a student-athlete to engage in a predefined activity at a college level;
reading the one or more alert definitions and comparing them to the one or more conclusions regarding eligibility so as to determine that an alert must be sent to one or more users; and
preparing and sending a message to said one or more users via the one or more user address identifiers provided in the one or more alert definitions.

16. The cloud-based academic management system of claim 15, wherein an academic record includes a list of courses taken by a student-athlete and a corresponding list of grades received by the student-athlete for said courses.

17. The cloud-based academic management system of claim 16, wherein a conclusion comprises a text string that indicates eligibility of a student-athlete to engage in a predefined activity at a college level.

18. The cloud-based academic management system of claim 17, wherein the step of authenticating submissions comprises soliciting credentials from a source of a submission and verifying said credentials against a list of trusted credentials so as to determine that said source is a trusted source.

19. The cloud-based academic management system of claim 18, wherein the step of providing authenticated access comprising soliciting credentials from a user and verifying said credentials against a list of authorized credentials so as to determine that said user is allowed access to the system.
